(19) United States
(12) Patent Application Publication
(10) Pub. No.: US 2022/0103438 A1
(43) Pub. Date: Mar. 31, 2022

(54) SYSTEM AND METHOD FOR ENHANCED PROFILING

(71) Applicant: FIELDS OF LEADS LTD, Tel-Aviv (IL)

(72) Inventors: Iftach Kerzner, Hod Hasharon (IL); Segev Shilton, Ramot Hashavim (IL)

(21) Appl. No.: 17/488,523

(22) Filed: Sep. 29, 2021

Related U.S. Application Data
(60) Provisional application No. 63/085,167, filed on Sep. 30, 2020.

(51) Int. Cl. H04L 12/24; G06F 16/9535; G06F 16/9538; G06F 9/451; G06F 3/0481; G06F 3/16; G10L 15/22; H04L 29/08

(52) U.S. Cl. CPC H04L 41/5058; G06F 16/9535; G06F 16/9538; H04L 67/306; G06F 3/0481; G06F 3/165; G10L 15/22; G06F 9/451

(57) ABSTRACT

A method for matching a user to a service provider, comprising: obtaining a user profile for a user capturing at least one of: a sought service type, service quality, service speed, a risk niche, a demographic niche, a socio-economic niche, a quote acceptance likelihood, a binding likelihood, and an expected life time value; obtaining multiple service provider profiles capturing at least one of: an offered service type, service quality, service speed, a target risk niche, a target demographic niche, a target socio-economic niche, a quote acceptance threshold, a binding threshold, and an expected user life time value threshold; matching the user with at least one service provider by fitting the respective profiles; presenting the matched service provider to the user; receiving a confirmation; establishing a channel between the user and the matched service provider; and providing at least one aspect of the user profile to the matched service provider.

### FIELD OF THE DISCLOSED TECHNIQUE

The disclosed technique relates to user interfaces, in general, and to methods and systems for dynamically adapting a user interface to suit a user profile, in particular.

### BACKGROUND OF THE DISCLOSED TECHNIQUE

Networked communications are facilitating commercial interactions at a growing scale in recent years. Many industries have seen significant disruptions as customers circumvent traditional agents with online platforms. Sectors such as airlines, car rentals, and hotel accommodations have seen a profound shift as customers use online matching engines to find packages tailored to their needs. This has allowed these industries to flourish and diversify into a growing number of niches, while providing customers with a rich variety of goods and services.

However, not all industries have been able to fully capitalize on these technologies. The insurance industry stands out from these other industries, due to the need for carefully screening applicants. Whereas purchasing an airline ticket is a relatively simple transaction of offer and acceptance, purchasing an insurance policy requires exchanging far more information. An insurance company targeting a specific niche may require a potential customer to fill out a long, detailed form, only to determine that the policy seeker is not suitable. This experience can leave the person frustrated after divulging private information.

From the customer's point of view, the wide range of available insurance products can leave customers confused over which product best meets their needs, and which provider is suited to their personal risk profile and their preferences. For example, some customers may prefer cheaper premiums over personalized service, and some the reverse. Company representatives offering advice over the various products may not have the customer's best interest in mind.

U.S. Pat. No. 7,640,176 B1 to Aldrich et al, titled “Insurance Agent Contact System” relates to an online system for facilitating the interaction between agents for insurance carriers and a customer. The customer is provided with an interface with which to enter customer information and preferences. The system uses the customer information and preferences about insurance agents and the policies they offer. Additionally, the customer information is delivered to the various agents.

U.S. Pat. No. 6,070,149 to Tavor et al, titled “Virtual Sales Personnel” relates to a method for enabling users to interact with an interactive sales representative system for sales guidance. The system collects parameters from the user to offer compatible products and services, or suggest suitable alternatives. The system then guides the user to choose a product and service to shorten the search cycle for the customer.

U.S. Pat. No. 8,484,046 B1 to Bauer et al, titled “Method and Apparatus for Internet On-Line Insurance Policy Service” relates to a system for facilitating real-time automated communication for insurance policies. The system allows the user to evaluate existing insurance policies and test variations to these polices to evaluate the changes in premiums. The user interface presents information specific to the customer, as well as generic information.

U.S. Pat. No. 6,697,824 B1 to Bowman-Amuah, titled “Relationship Management in an E-Commerce Application Framework” relates to a system and method for interacting with a user over a network. The user is presented with a website displaying a plurality of different contents. The contents that are displayed are selected according to a match between attributes of the contents to attributes of the user's profile.

### SUMMARY OF THE PRESENT DISCLOSED TECHNIQUE

It is an object of the disclosed technique to provide a novel method and system for providing a method for matching a user to a service provider, the method comprising: communicating with a user via a user device; obtaining a user profile associated with the user, the user profile based on at least one factor selected from the group consisting of: a sought service type, a sought service quality, a sought service speed, a risk niche, a demographic niche, a socio-economic niche, an age attribute, a health attribute, a quote acceptance likelihood, a binding likelihood, an expected life time value, a probability of fraud, user intent, and a probability of conversion via a fully online process; obtaining multiple service provider profiles, each associated with a different provider for a service, wherein each service provider profile is based on at least one factor selected from the group consisting of: an offered service type, an offered service quality, an offered service speed, a target risk niche, a target demographic niche, a target socio-economic niche, a quote acceptance threshold, a binding threshold, and an expected user life time value threshold; matching the user with at least one of the multiple service providers by fitting at least one factor of the user profile to at least one factor of at least one of the multiple service provider profiles; presenting the matched one of the multiple service providers to the user; receiving a confirmation from the user regarding the matched one of the multiple service providers; establishing a channel between the user and the matched one of the multiple service providers; and providing at least one aspect of the user profile to the matched one of the multiple service providers.

In some embodiments, the method further comprises creating the user profile by: providing an adaptive user interface (UI) configured to at least visually engage in an interactive communication with the user; displaying on the user device, via the adaptive UI, an image prompting the user to provide a first response; receiving the first response via the adaptive UI; deriving a first user characteristic based on at least one of multiple information vectors associated with the user, the multiple information vectors comprising at least the adaptive UI; applying the first user characteristic to dynamically modify a display property of a follow-up image prompting the user for a second response via the adaptive UI, wherein the modified display property is configured to facilitate the engagement with the user via the adaptive UI; displaying the follow-up image via the adaptive UI; receiving the second response; deriving a second user characteristic for the user based on the second response; and applying at least one of the first user characteristic and the second characteristic to create a user profile for the user.

There is provided, in accordance with another embodiment of the disclosed technique, a system for matching a user to a service provider, the system comprising: a communication network; and a server computing device comprising at least one server-side processor, the server side computing device configured to communicate with multiple user devices and multiple service provider devices via a communication channel of the communication network, wherein the at least one server-side processor is configured to: obtain a user profile associated with the user, the user profile based on at least one factor selected from the group consisting of: a sought service type, a sought service quality, a sought service speed, a risk niche, a demographic niche, a socio-economic niche, an age attribute, a health attribute, a quote acceptance likelihood, a binding likelihood, an expected life time value, a probability of fraud, user intent, and a probability of conversion via a fully online process; obtain multiple service provider profiles, each associated with a different provider for a service, wherein each service provider profile based on at least one factor selected from the group consisting of: an offered service type, an offered service quality, an offered service speed, a target risk niche, a target demographic niche, a target socio-economic niche, a quote acceptance threshold, a binding threshold, and an expected user life time value threshold; match the user with at least one of the multiple service providers by fitting at least one factor of the user profile to at least one factor of at least one of the multiple service provider profiles; present the matched one of the multiple service providers to the user; receive a confirmation from the user regarding the matched one of the multiple service providers; establish a channel between the user and the matched one of the multiple service providers; and provide at least one aspect of the user profile to the matched one of the multiple service providers.

In some embodiments, the server-side processor is further configured to create the user profile by: providing an adaptive user interface (UI) configured to at least visually engage in an interactive communication with the user; displaying on the user device, via the adaptive UI, an image prompting the user to provide a first response; receiving the first response via the adaptive UI; deriving a first user characteristic based on at least one of multiple information vectors associated with the user, the multiple information vectors comprising at least the adaptive UI; applying the first user characteristic to dynamically modify a display property of a follow-up image prompting the user for a second response via the adaptive UI, wherein the modified display property is configured to facilitate the engagement with the user via the adaptive UI; displaying the follow-up image via the adaptive UI; receiving the second response; deriving a second user characteristic for the user based on the second response; and applying at least one of the first user characteristic and the second characteristic to create a user profile for the user.

In some embodiments, the adaptive UI further includes an audio-based UI equipped with an automated agent configure to: audibly engage in a conversation with the user by: playing an audio stream prompting the user to provide a first voice response, and receive the first voice response, wherein the computing device is further configured to derive a third user characteristic for the user based on the first voice response, and apply the third user characteristic to dynamically modify a property of the adaptive UI relating to at least one of a follow-up audio stream and a second follow-up image, wherein the modified property is configured to facilitate the engaging with the user.

In some embodiments, the modified property relates to the follow-up audio stream, the property selected from the group consisting of: a message content, a volume level, a word enunciation rate, a pitch, a tone, an accent, a gender characteristic, an age characteristic, and an accent characteristic.

There is provided, in accordance with another embodiment of the disclosed technique, a method for creating a user profile via a dynamically adaptive user interface (UI), the method comprising the procedures of: providing an adaptive user interface (UI) configured to at least visually engage in an interactive communication with a user via a user device; displaying on the user device, via the adaptive UI, an image prompting the user to provide a first response; receiving the first response via the adaptive UI; deriving a first user characteristic based on at least one of multiple information vectors associated with the user, the multiple information vectors comprising at least the adaptive UI; applying the first user characteristic to dynamically modify a display property of a follow-up image prompting the user for a second response via the adaptive UI, wherein the modified display property is configured to facilitate the engagement with the user via the adaptive UI; displaying the follow-up image on the user device via the adaptive UI; receiving the second response via the adaptive UI; deriving a second user characteristic for the user based on the second response; and applying at least one of the first user characteristic and the second characteristic to create a user profile for the user.

In some embodiments, the modified display property is selected from the group consisting of: a font size, a font style, a font color, a background color, a background texture, a background context, a display orientation, a display content characteristic, an image size, an image style, an image color, an image brightness, an image saturation, an image resolution, an image opacity, and an image context.

In some embodiments, the method further comprises providing an automated agent configured to audibly engage in a conversation with the user via the user device, playing on a speaker of the user device, via the automated agent, an audio stream prompting the user to provide a first voice response, receiving the first voice response, deriving a third user characteristic for the user based on the first voice response, and applying the third user characteristic to dynamically modify a property of at least one of a follow-up audio stream and a second follow-up image, wherein the modified property is configured to facilitate the engaging with the user.

In some embodiments, the method further comprises playing the follow-up audible stream via the automated agent, receiving a second voice response to the follow-up audible stream, deriving a fourth user characteristic for the user based on the second voice response, and applying at least one of the third user characteristic and the fourth characteristic to create the user profile.

In some embodiments, the method further comprises matching the user with one of multiple service providers by fitting at least one factor of the user profile to at least one factor of at least one of the multiple service provider profiles.

In some embodiments, the method further comprises receiving a confirmation from the user with respect to the matching, establishing a communication channel between the user and the matched one of the multiple service providers, and providing, to the matched one of the multiple service providers, at least one aspect of the user profile.

In some embodiments, the method further comprises creating the multiple service provider profiles corresponding to each of the multiple service providers.

There is provided, in accordance with another embodiment of the disclosed technique, a system for creating a user profile via a dynamically adaptive user interface (UI), the system comprising: a communication network; and a server computing device comprising at least one server-side processor, the server side computing device configured to communicate with multiple user devices and multiple service provider devices via a communication channel of the communication network, wherein the at least one server-side processor is configured to: provide an adaptive user interface (UI) for at least visually engaging in an interactive communication with a user of the user device, display, on the user device via the adaptive UI, an image prompting the user to provide a first display response; receive the first display response; derive a first user characteristic based on at least one of multiple information vectors associated with the user, the multiple information vectors comprising at least the first display response; apply the first user characteristic to dynamically modify a display property of a follow-up image prompting the user for a second display response via the adaptive UI, wherein the modified display property is configured to facilitate the engagement with the user via the adaptive UI; display the follow-up image on the user device via the adaptive UI; receive the second display response; derive a second user characteristic for the user based on the second display response; and apply at least one of the first user characteristic and the second characteristic to create a user profile for the user.

In some embodiments, the user profile is based on at least one factor selected from the group consisting of: a sought service type, a sought service quality, a sought service speed, a risk niche, a demographic niche, a socio-economic niche, an age attribute, a health attribute, a quote acceptance likelihood, a binding likelihood, an expected life time value, a probability of fraud, user intent, and a probability of conversion via a fully online process.

In some embodiments, the multiple information vectors further comprise a vector selected from the group consisting of: a behavior of the user while engaging with the adaptive UI, a hardware configuration of the user device, a software configuration of the user device, a type of the user device, a characteristic of the communication channel, a bandwidth rate, a geographic location of the user device, a location type associated with the geographic location, an ad vector facilitating the engaging with the user, a search query facilitating the engaging with the user, a time of the visually engaging in the interactive communication, a date of the visually engaging in the interactive communication, and an anomaly associated with the user.

In some embodiments, the behavior is selected from the group consisting of: a data entry rate, a delay, an error rate, an error type, and use of an auto-fill tool.

In some embodiments, the adaptive UI is further equipped with an automated agent configured to audibly engage in a conversation with the user by playing an audio stream prompting the user to provide a first voice response, and receiving the first voice response via a microphone of the user device, wherein the at least one server-side processor is further configured to derive a third user characteristic for the user based on the first voice response, and apply the third user characteristic to dynamically modify a property of the adaptive UI relating to at least one of a follow-up audio stream and a second follow-up image, wherein the modified property is configured to facilitate the engaging with the user.

In some embodiments, the automated agent is further configured to play the follow-up audible stream, and receive a second voice response to the follow-up audible stream, and wherein the computing device is further configured to derive a fourth user characteristic for the user based on the second voice response, and apply at least one of the third user characteristic and the fourth characteristic to create the user profile.

In some embodiments, the third user characteristic and the fourth user characteristic are derived based on an attribute of at least one of the first voice response and the second voice response, the attribute selected from the group consisting of: a message content, a word enunciation rate, a volume, a pitch, a tone, an accent, a gender characteristic, and an age characteristic.

In some embodiments, the dynamically modified property is of the follow-up audio stream, the property selected from the group consisting of: a message content, a volume level, a word enunciation rate, a pitch, a tone, an accent, a gender characteristic, an age characteristic, and an accent characteristic.

In some embodiments, the at least one server-side processor is further configured to match the user with one of multiple service providers by fitting at least one factor of the user profile to at least one factor of at least one of the multiple service provider profiles.

In some embodiments, the service provider profiles are based on a criterion selected from the group consisting of: a service type, a service quality, a service speed, a demographic niche, a socio-economic niche, a tolerance threshold relating to a probability of the user accepting a quote, a tolerance threshold relating to binding the user to an offer, and a tolerance relating to an expected user life time value.

In some embodiments, the at least one server-side processor is further configured to receive a confirmation from the user with respect to the matching, establish a communication channel between the user and the matched one of the multiple service providers, and provide, to the matched one of the multiple service providers, at least one aspect of the user profile.

In some embodiments, the at least one server-side processor is further configured to create the multiple service provider profiles corresponding to each of the multiple service providers.

### BRIEF DESCRIPTION OF THE DRAWINGS

The disclosed technique will be understood and appreciated more fully from the following detailed description taken in conjunction with the drawings in which:

FIG. 1A shows a client side computing device, constructed and operative in accordance with an embodiment of the disclosed technique;

FIG. 1B shows a server side computing device constructed and operative in accordance with another embodiment of the disclosed technique;

FIGS. 2A-2B which, taken together, are a schematic illustration of a system for matching a user with a service provider, constructed and operative in accordance with a further embodiment of the disclosed technique;

FIGS. 3A-3D, taken together, are a schematic illustration of an exemplary dynamically adaptive display-based user interface (UI) for collecting information to create a user profile, constructed and operative in accordance with another embodiment of the disclosed technique;

FIGS. 4A-4B taken together, illustrate another exemplary implementation of an adaptive UI, constructed and operative in accordance with another embodiment of the disclosed technique;

FIG. 5A is a flowchart of a method for creating a user profile via a dynamically adaptive user interface (UI), constructed and operative in accordance with another embodiment of the disclosed technique;

FIG. 5B is a flowchart of a method for creating a user profile via a dynamically adaptive user interface (UI), constructed and operative in accordance with a further embodiment of the disclosed technique;

FIG. 5C is a flowchart of a method matching a user to one of multiple candidate service providers, constructed and operative in accordance with another embodiment of the disclosed technique;

### DETAILED DESCRIPTION OF THE EMBODIMENTS

The disclosed technique overcomes the disadvantages of the prior art by providing an automated system to implement a two-way matching between a user and at least one service provider. A dynamically adaptive user interface (UI) is provided to facilitate the engagement with the user for the purpose of creating an enhanced user profile. The enhanced user profile is subsequently used by a matching engine to match the user to one or more service providers, such as an insurance company which typically requires comprehensive and accurate information. The enhanced user profile is used to screen the user to fit the preferences of different service providers, and additionally to satisfy the preferences of the user, thereby improving the odds that an offer by the service provider will be accepted by the user, and the engagement will lead to a binding agreement.

To create the enhanced user profile, the disclosed technique collects and analyzes data along multiple information vectors, described in greater detail below. The collected data is used to derive one or more user characteristics. The user characteristics may subsequently contribute to creating the user profile. Additionally or alternatively, the user characteristics may be used to modify the adaptive UI to facilitate the continued engagement with the user, and enable the continued collection of information. Consequently, a more robust set of information is collected about the user that what would be collected using conventional techniques. This may lead to a more satisfactory user experience, and greater accuracy in matching the user to one of the service providers, which may improve the odds that the two will reach a satisfactory agreement.

The data content provided by the user in response to a prompt by the adaptive UI is but one information vector for collecting information about the user. Additional information vectors include any of: the behavior of the user while engaging with the UI, the hardware and software configuration of the user's device, location data of the user, the bandwidth of the communication channel over which the user is communicating, the channel type, the Internet service provider, a query term or ad vector used by the user, and the like. Information collected along these vectors is used to create the user profile and/or additionally, to dynamically modify the adaptive UI to facilitate her continued engagement. For example, a slower than average typing speed may indicate that the user has difficulty reading the content displayed by the adaptive UI. Consequently, follow-up content would be displayed in a larger, clearer font, to prevent the user from quitting the application out of frustration. Additionally, a slow typing rate may indicate a health or age characteristic relevant to the user profile.

Thus, an earlier engagement with the user may be used to dynamically modify follow-up engagements and promote a continued engagement so that more information can be collected about the user. Consequently, the user profile is enhanced, being based on multiple information vectors over a lengthier engagement. The enhanced user profile is more comprehensive and robust than a user profile created using conventional techniques.

A matching engine compares the enhanced user profile with the profiles of one or more service providers. Matching based on the enhanced user profile increases accuracy, and increases the probability that a good fit will be found between the user and one of the service providers. This in turn increases the odds that a satisfactory agreement will be reached between the user and the service provider.

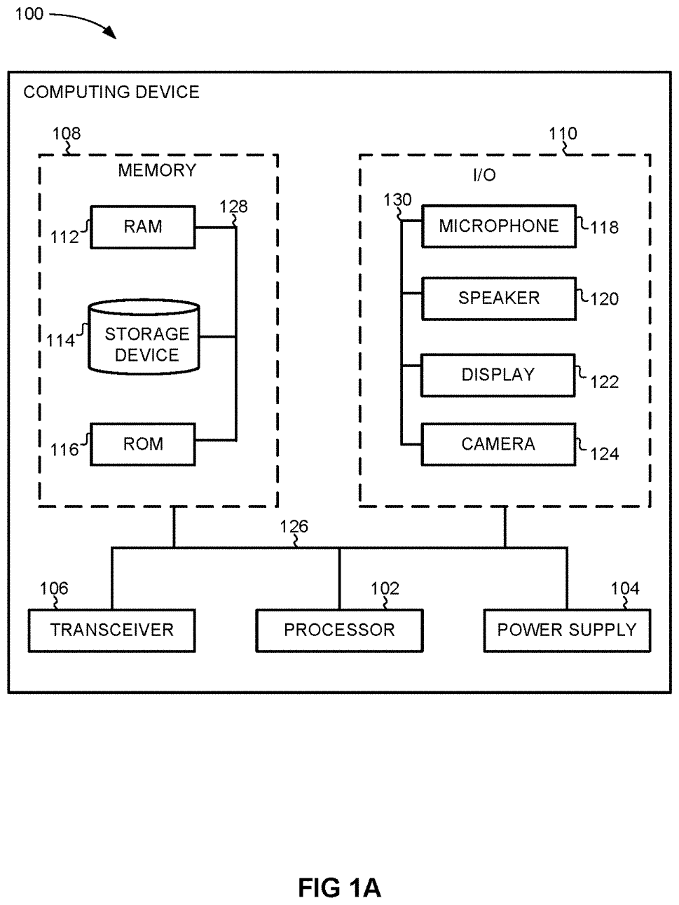

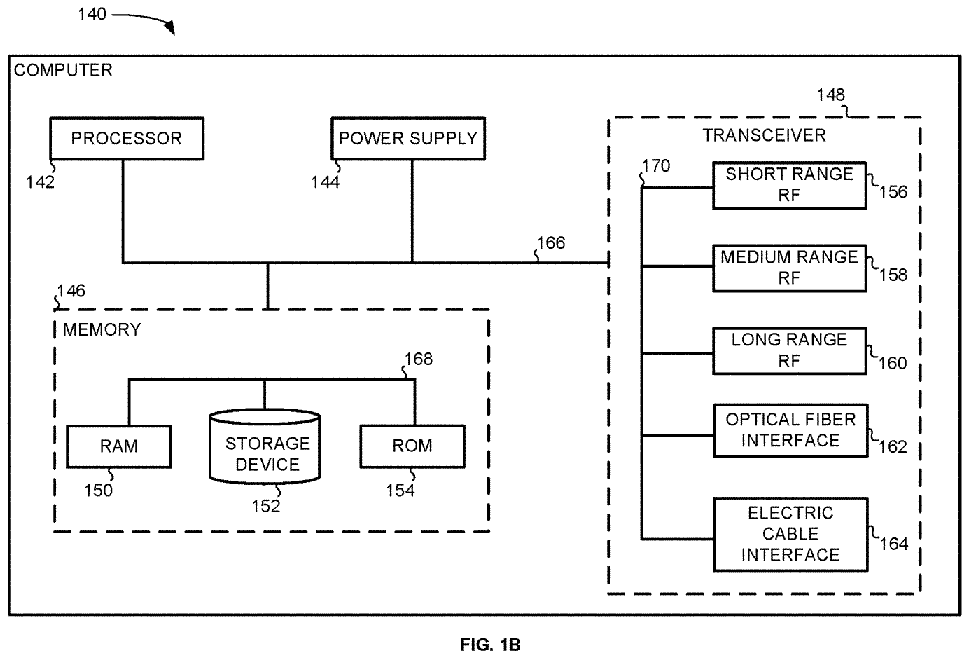

Reference is now made to FIG. 1A which shows a client side computing device, generally referenced 100, constructed and operative in accordance with an embodiment of the disclosed technique. Computing device 100 includes at least one processor 102, a power supply 104, at least one transceiver 106, at least one memory 108, and an input/output (I/O) interface 110. I/O interface 110 may include any of a microphone 118, a speaker 120, a display 122, such as a touch-based screen, and a camera 124. Memory 108 is a computer-readable medium configured to store one or more program code instructions for execution by processor 102, and includes one or more of a random access memory (RAM) 112, read-only memory (“ROM) 116, a local or remote cloud-based storage device and/or a removable storage device, collectively referred to as storage device 114. Transceiver 106 is configured to communicate with other computing devices via wired (e.g. cable and/or fiber) and wireless (e.g. short, medium and long wavelength radio signals) means. Processor 102, power supply 104, transceiver 106, memory 108, and I/O interface 110 are electrically coupled via a bus system 126. RAM 112, ROM 116, and storage device 114 are electrically coupled via a bus system 128. Microphone 118, speaker 120, display 122, and camera 124 are electrically coupled via a bus system 130. Microphone 118 is configured to detect voice signals and convert these to a format suitable for transmission, i.e. by converting the voice signal to an electric signal, or to a radio signal for transmitting via transceiver 106. Speaker 120 is configured to convert an electric signal to an audio signal. Display 122 is configured to display data and receive user input via a conventional user input device, such as a keyboard, mouse, electronic pen, one or more buttons and touch sensitive sensors, and the like.

Computing device 100 may be any of: a cellular phone, a laptop computer, a desktop computer, a tablet computer, and the like, and is intended to illustrate an exemplary implementation for a client side computing device and does not limit the invention to a specific hardware implementation. Although FIG. 1A shows computing device 100 as a stand-alone device, this is for illustrative purposes only. In some implementations, the components of computing device 100 are logical or virtual representations of multiple physical components distributed over multiple devices at one or more physical locations, and that operate in a coordinated manner to carry out operations of the present invention, as is known in the art of distributed computing.

Reference is now made to FIG. 1B, which shows a server side computing device, generally referenced 140, constructed and operative in accordance with another embodiment of the disclosed technique. Computing device 140 includes at least one processor 142, a power supply 144, at least one memory 146, and at least one transceiver 148. Memory 146 is a computer-readable medium configured to store one or more program code instructions for execution by processor 142, and includes one or more of a random access memory (RAM) 150, read-only memory (“ROM) 154, a local or remote cloud-based storage device and/or a removable storage device, collectively referred to as storage device 152. Storage device 152 may include one or more databases storing data pertaining to users, service providers, and the like. Transceiver 148 is configured to communicate with additional devices, such as computing device 100 (FIG. 1A) via wired or wireless means, and includes one or more of a short range radio frequency (RF) transceiver 156, a medium range radio frequency (RF) transceiver 158, a long range radio frequency (RF) transceiver 160, an optical fiber interface 162, and an electric cable interface 164. Processor 142, power supply 144, memory 142, and transceiver 148 are electrically coupled via a bus system 166. RAM 150, ROM 152, and storage device 154 are electrically coupled via a bus system 168. Short range RF 156, medium range RF 158, long range RF 160, optical fiber interface 162, and electric cable interface 162 are electrically coupled via a bus system 170. In some implementations, the components of computing device 140 are logical or virtual representations of multiple physical components distributed over multiple devices at one or more physical locations, and that operate in a coordinated manner to carry out operations of the present invention, as is known in the art of distributed computing.

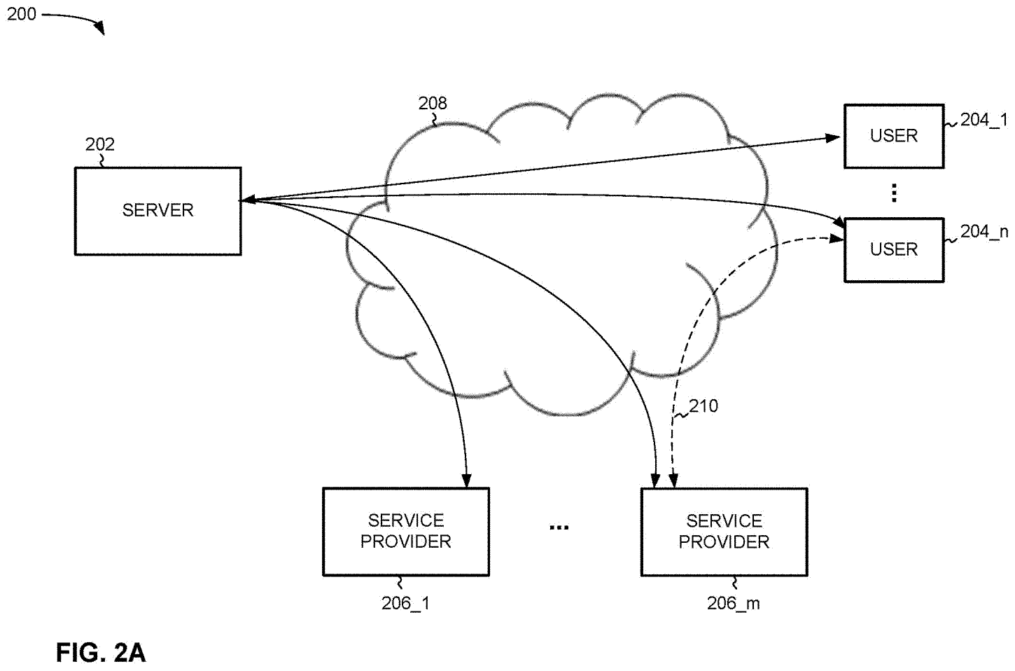

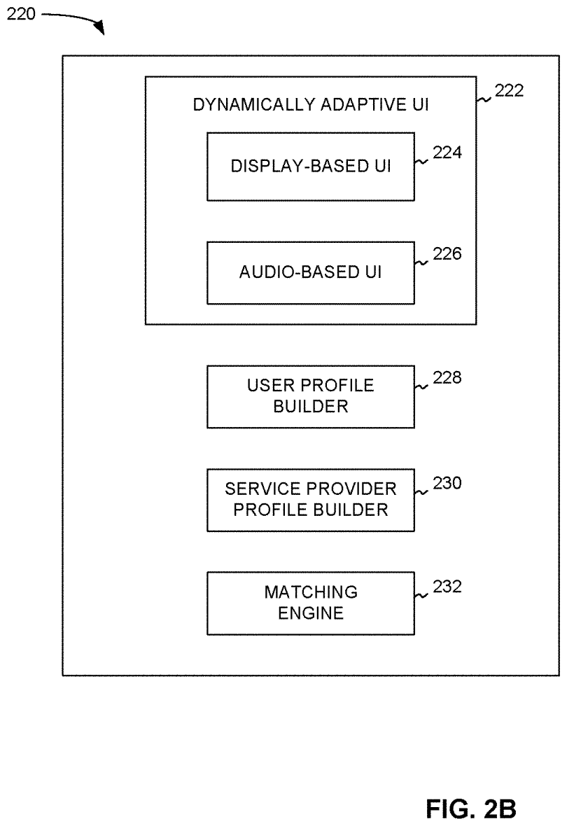

Reference is now made to FIGS. 2A-2B which, taken together, are a schematic illustration of a system, generally referenced 200, for matching a user with a service provider, constructed and operative in accordance with a further embodiment of the disclosed technique. Referring to FIG. 2A, system 200 includes a server 202, multiple user devices 204_1 . . . 204_n, multiple service provider devices 206_1 . . . 206_m, and a communication network 208, such as the Internet. In the examples that follow, server 202 is an exemplary instance of device 140 (FIG. 1B), and user devices 204_1 . . . 204_n, and service provider devices 206_1 . . . 206_m are exemplary instances of device 100 (FIG. 1A). In the description that follows, program code instructions executed by server 202 are understood to be executed by processor 142 of device 140 representing server 202. Similarly, program code instructions executed by any of user devices 204_1 . . . 204_n, and service provider devices 206_1 . . . 206_m are understood to be executed by processor 102 of device 100, representing any of user devices 204_1 . . . 204_n, and service provider devices 206_1 . . . 206_m. Server 202 and user devices 204_1 . . . 204_n communicate over network 208 via transceivers 148 and 106, respectively, allowing the users of devices 204_1 . . . 204_n to engage with the dynamically adaptive UI for the purpose of creating an enhanced user profile. Server 202 collects information for each user along multiple information vectors, and stores the information in memory 146 for the purpose of creating an enhanced user profile for each user. In addition, server 202 communicates with service provider devices 206_1 . . . 206_m over network 208 via transceivers 148 and 106, respectively. Server 202 collects information from each respective service provider, and stores the information in memory 146 for the purpose of creating a profile for each service provider. Server 202 stores the service provider profiles in memory 146. Server 202 matches at least one of the users to at least one of the service providers by comparing the enhanced user profile for each user against the service provider profiles. In the example shown, server 202 has matched the user of user device 204_n with the service provider of device 206_m.

After receiving a confirmation for the match from the user and/or the service provider, server 202 establishes a direct communication channel between the respective devices for each. In the example of FIG. 2A, server 202 establishes channel 210 to directly connect user device 204_n with service provider device 206_m based on the matching between the user of device 204_n with the service provider of device 206_m. In some embodiments, server 202 provides one or more aspects of the enhanced user profile, stored in memory 146, to the matched service provider.

Referring to FIG. 2B, an exemplary implementation for a server-side software architecture, generally referenced 220 is shown. The program code instructions of software architecture 220 are stored in memory 146 for execution by processor 142 (FIG. 1B) of server 202. Software architecture 220 includes a dynamically adaptive UI 222, which includes a display-based UI 224 and an audio-based UI 226. Software architecture 220 additionally includes a user profile builder 228, a service provider profile builder 230, and a matching engine 232.

Server 202 executes dynamically adaptive UI 222 to engage with the users of user devices 204_1 . . . 204_n. Display-based UI 224 displays one or more electronic forms prompting the users to respond by entering data. In some embodiments, audio-based UI 226 enables server 202 to engage in an audio conversation with the users. Audio-base UI 226 includes an automated agent equipped with a voice synthesizer and a voice recognition module for engaging in automated, synthesized speech with the users.

While engaging with the users via adaptive UI 222, server 202 collects information about the user via multiple information vectors, and stores the information at memory 146. At least one information vector is the data content provided directly by the user in response to prompts by adaptive UI 222. For example, the user may provide the data content by entering data into an electronic form of display-based UI 224, selecting an option via display-based UI 224, using an auto-fill option, providing audio data to an automated agent of audio-based UI 226 by speaking into a microphone, and the like.

Another information vector may be the behavior of the user while engaging with dynamically adaptive UI 222, such as the typing rate, error rate, and delays. For example, a slower than an average data entry rate, a hesitancy or delay in filling in one or more of the displayed fields, a higher than average error rate in data entry, such as typos or entering letters into numerical fields, difficulty in manipulating an electronic mouse or pen, may indicated that the user has difficulty seeing the letters and fields displayed in electronic form 302. This may be related to age, disability, lack of familiarity with technology, and the like. As another example, use of auto-fill tool may indicate a level of sophistication by the user indicating a socio-economic demographic.

Another information vector may be the hardware and/or software configuration of the device used by the user to engage with server 202. Certain models of devices manufactured by certain companies may indicate a socio-economic, demographic or social category, for example a mobile device versus a desktop computer may indicate age or mobility characteristics about the user. Server 202 may use one or more of the type, model or brand of the user device, and/or the operating system and browser to determine one or more characteristics about the user.

Another information vector may be the communication channel characteristics, such as the connection type, the line type, the available bandwidth, and the Internet service provider (ISP) used for communicating with the user. The amount of available bandwidth may indicative of the demographic of socio-economic classification of the user, or the technological savviness off the user. Similarly, the type of communication channel, e.g. cable, fiber, satellite, may indicate one or more user characteristics.

Another information vector may be an ad vector that brought the user to a landing page associated with server 202. For example, ads targeting certain socio-demographic types may indicate characteristics relevant to the user profile and/or to modifying dynamically adaptive UI 222 to facilitate continued engagement. Server 202 may use ad details such as the campaign identity, campaign structure, ad channel, ad group, and creative to determine one or more relevant user characteristics.

Another information vector may be a search query term entered by the user that led the user to the landing page associated with server 202. For example, the query term may indicate the type, quality, and speed of service sought by the user, as well as socio-economic, demographic and risk attributes of the user.

Another information vector may be the time (adjusted for time zone of current location) or date chosen by the user to engage with system 200. Server 202 may use details such as the current hour, day of week, week of the year, month, quarter and year, holiday, weekday, or weekend to determine one or more characteristics about the user.

Another information vector may be the current geographic location of the user while communicating with server 202. Details such as the user's current area code, zip code, zip code group, city, state, and country may provide relevant information to determine one or more user characteristics, such as socio-economic niche, risk attributes, and characteristics relating to the type, quality, and speed of service sought by the user.

Another information vector may be the current location type (e.g. residential, café, library, school) which may indicate socio-economic or demographic details relating to risk factors, and/or type, quality, and speed of service sought by the user.

Another information vector may be the home residence of the user, which may differ from the current location of the user communicating with server 202. Details such as the area code, zip code, zip code group, city, state, and country may provide relevant information to determine one or more user characteristics relating to the user profile.

Additionally, discrepancies or anomalies detected regarding the information collected about the user may indicate certain risk factors. For example, an anomaly between the current location of the user (e.g. a university library) and a home address associated with high crime may indicate a lower risk than would typically associated with the home address. Conversely, a request to insure a luxury car by an individual living in a crime-ridden neighborhood may indicate a higher than average risk factor. An anomaly between the device type of the user (high end) versus the address of the user (low socio-economic category) may indicate a higher risk profile. These and other anomalies detected from the information collected via the multiple information vectors indicating inconsistencies may indicate risk factors relevant to the service provider.

The list of information given is not intended as exhaustive, but rather to exemplify the type and range of information collected by server 202 about the user. Details such as the age, age group, health, family status, gender, homeowner status, type of home, home location, employment status, employment location, education, insured status, identity of current insurer, type of vehicle owned, number of vehicles owned, and the year, model, make, and body style of the vehicle, acquired either directly or by inference may be used to determine one or more user characteristics. Server 202 may apply any suitable technology, such as one or more of machine learning, artificial intelligence, statistical regression and correlation, curve fitting and the like, to determine the user characteristics.

The user characteristics determined from the information collected along one or more of the information vectors mentioned above may relate to one or more of: the probability that the user will defraud a service provider; assumptions related to the age, health, and intent of the user; the intent of the user in purchasing a service such as an insurance policy; the type, targeted cost, timing, and quality of the service sought; the probability that the user will be converted to purchasing a service via a fully online process without requiring assistance from a human agent, and the like.

For example, server 202 may apply the form completion time to determine user characteristics regarding the probability that the user will defraud a service provider, the health of the user, the intent of the user, the probability that the user will purchase an insurance policy, and the probability that the conversion in purchasing an insurance policy can be completed via a fully online process. As another example, server 202 may apply typing characteristics (e.g. speed, number of typos) and/or the user device type to determine characteristics related to the probability of fraud, and/or assumptions about age. As a further example, server 202 may apply the Internet connection type to determine characteristics related to the age or socioeconomic niche of the user. As another example, server 202 may apply the time taken by the user to answer specific questions to determine user characteristics related to the probability of fraud, the user intent, the probability that the user will purchase an insurance policy, and the probability that the conversion may be completed in a fully online process.

Server 202 executes profile builder 228 to create a profile for each user of devices 204_1 . . . 204_n from the information collected from each user. The user profiles are created using any suitable technique, such as statistical regression, correlation, machine learning, artificial intelligence, and the like. Each user profile may include one or more of: user intent, a sought service type, a sought service quality, a target service cost, a target service speed (e.g. time to acquire policy, and/or expected time to receive payment after filing a claim), a risk profile or niche, a demographic or socio-economic profile or niche, health and age attributes, a probability that the user will accept a quote (quote acceptance likelihood), a probability that the user will bind to an offer made by a service provider, an expected life time value for the user, a probability that the user will commit fraud, and a probability of converting the user (i.e. reaching a binding agreement) via a fully online process.

For example, system 200 may be useful to insurance providers, which typically require highly detailed information about users. Issuing a quote for an insurance policy often requires the work of highly skilled individuals and imposes significant costs. Insurance providers may wish to screen users who do not fall into their preferred customer niche to save such costs. The enhanced user profile of the disclosed technique may help filter out users that are less suitable to one provider, and direct those users to other, more suitable providers.

The user profile may include the type of insurance sought by the user, such as home, car, or life insurance, and the quality of service and/or cost tradeoff sought by the user. For example, some users may prefer a premium personalized service whereas others might prefer a discounted automated service. The user profile may include a speed factor, for example if the user urgently requires travel insurance and is willing to pay a premium for an expedited service. The user profile may include risk factors based on lifestyle, family history, personal status, personal history, and the like. The user profile may include socio-economic and/or demographic factors relating to the user's age, lifestyle, economic factors, social factors and expected life time value. The user profile may include behavioral aspects that indicate if the user will accept a quote by an insurance company and enter into a binding agreement. For example, consistency across multiple user characteristics may indicate a higher probability of entering into an agreement, whereas an inconsistency or anomaly across one or more user characteristics may indicate a lower probability of entering into a binding agreement. Similarly, consistency across multiple factors may indicate reliability, whereas inconsistency may indicate a risk that the user will defraud the service provider. By creating a robust user profile via the adaptive UI, the disclosed technique helps to screen users and direct them to suitable service providers, thereby increasing the probability that the user and the matched service provider will enter into a binding agreement.

Additionally, server 202 applies at least some of the information collected along any of the information vectors listed above to dynamically modify aspects of adaptive UI 222, while engaging with the user. The dynamic modification is intended to facilitate the continued engagement with the user, to improve the user experience and enable the collection of additional information.

For example, server 202 applies the collected information to dynamically modify a display attribute of display-based UI 224, including any of: a font size, a font style, a font color, a background color, a background texture, a background context, a display orientation, a text content, an image content, an image size, an image style, an image color, an image brightness, an image saturation, an image resolution, an image context, the inclusion or exclusion of a select option, a style, color, size, order, arrangement, brightness or context of displayed select options, the number and length of prompts (i.e. questions), the inclusion or exclusion of prompts to present to the user, the number and/or type of options presented as candidate answers to prompts, and the number of offers subsequently presented to the user as candidate matches,

Server 202 may apply the amount of time taken by the user to answer a question via dynamically adaptive UI 222 to subsequently modify aspects of dynamically adaptive UI 222 and/or predict user characteristics for matching purposes. For example, a delay in receiving a response may cause server 202 to subsequently modify a display characteristics of display-based US 224, such as by displaying text using a larger or clearer font, displaying more graphics and less text, or to offer the user assistance, such as via an automated agent (e.g. chat or voice configured with audio-based UI 226), or to continue the engagement off-line with a human agent.

In some implementations, a detected geolocation is used to predict user attributes for matching purposes and/or to modify adaptive UI 222. For example, certain geolocations may be associated with certain user preferences. Consequently, server 202 may modify one or more form attributes, such as the color, shape, style and size of the text and/or graphics to conform to regional tastes. Similarly, the wording of questions may be modified to suit the social and cultural attributes associated with the geolocation.

In some implementations, the type of device used by the user to communicate with server 202 is used for matching purposes and/or to modify adaptive UI 222. Server 202 may apply the device type to predict user preferences regarding the user interface, and may modify attributes such as the color, shape, size of displayed text and/or graphics, and the phraseology and syntax of the displayed text. For example, a desktop computer may indicate an older person with more conservative tastes, whereas a new model for a mobile phone may indicate a younger person with more current tastes. As another example, a user engaging with system 200 with a mobile phone in motion versus a desktop computer situated in a library may distinguish between a casual shopper for a service (e.g. the former) and someone deliberately seeking a service (e.g. the latter).

In some implementations, the type of communication connection, such as cable, fiber, satellite, and/or the bandwidth capacity (e.g. 4G or 5G) may be used for matching purposes and/or to modify adaptive UI 222. Server 202 may apply the communication characteristics to predict user tastes and modify dynamically adaptive UI 222 accordingly, by modifying the color, shape, and size of displayed text or graphics, the context and/or syntax and phraseology of the text instructing, guiding, informing or prompting the user, the type and/or number of graphics displayed, and/or the method used to load a page displayed to the user.

In some implementations, server 202 applies specific user attributes such as the type of car driven by the user (e.g. sports utility vehicle, convertible sports car, luxury car, minivan), the type of home the user lives in (private home, condominium, apartment rental), personal status, employment status, and the like to predict user preferences for modifying any of the attributes of adaptive UI 222.

In some embodiments, an automated voice-driven agent, configured with audio-based UI 226, engages with the user in a conversation. Techniques such as machine learning, artificial intelligence, and the like, may be utilized to simulate a human agent for the automated agent of audio-based UI 226. The automated agent generates an audio stream that server 202 provides to the user (e.g. device 204_n) over network 208. The audio stream may inform, instruct, guide and/or prompt the user to respond vocally to provide additional information. Server 202 may use attributes the vocal response to determine one or more user characteristics. Voice attributes may include one or more of a word enunciation rate, volume, tone, background noise, a detected accent, gender, age, regional or cultural based syntax, and the like.

For example, in response to a slower than average speech rate by the user, the automated voice-driven agent may modify a follow up audio stream accordingly, by slowing the speech rate to match the speech of the user, using simpler words, or increasing the volume. In response to a detected geo-location of the user or regional accent, the automated voice-driven agent may modify the accent of a follow up audio stream to conform to the region or detected accent. Similarly, the automated voice-driven agent may modify a gender or age characteristic of the follow-up audio stream in response to a detected gender or age of the user, respectively.

Server 202 additionally collects information about the service providers, either directly from each service provider or from other sources, such as online surveys, consumer reports, user feedback, and the like. Server 202 executes service provider profile builder 230 to apply the information collected about the multiple service providers to create a profile for each service provider. The service provider profile may include factors such as service type, quality, speed, targeted demographic niche, targeted socio-economic niche, to name but a few.

For example, the service providers may be insurance providers. The service provider profile may include factors relating to the type of insurance, such as car, life, travel, or home insurance. The service provider profile may include factors relating to quality of service, such as the degree of accessibility that the user has to information from the insurance provider for filing a claim, qualifying for a policy, disclaimers, and the like. Service quality may relate to ease in obtaining information by engaging with a human agent, an automated agent, a website of the insurance provider, and the like. The service provider profile may include factors relating to service speed, such as the expected response time for inquiries by users or potential users, the expected turnaround time from when a user first approaches the insurance provider until the user acquires a policy, the expected response time between filing a claim and receiving a payment, and the like. The service provider profile may include a niche targeted by the insurance provider, such as a demographic niche, socio-economic niche, risk profile niche, and the like.

For example, one or more of the following service provider preferences may be used to create the service provider profile. Some insurance providers may prefer targeting wealthier clients to whom they provide a personalized customer service in exchange for a premium fee. Other insurance providers may prefer targeting clients of lesser means to whom they provide a lower quality customer service at a discount. Similarly, some insurance providers may prefer taking on higher risk clients from whom they can charge a higher premium, whereas other service providers prefer taking on lower risk clients from whom they charge a lower premium. Some insurance providers may prefer to only engage with users who exhibit a high probability of accepting a quote. In this case, the service provider profile may include a quote threshold. Only users whose quote profiles are equal to or exceed the quote threshold of the service provider will be matched to the respective service provider. Some insurance providers may prefer to engage with users exhibiting a high probability of binding (purchasing an insurance policy). In this case, the service provider profile may include a binding threshold. Only users exhibiting a probability of binding that equals to, or exceeds the binding threshold will be matched to the respective insurance provider. Some insurance providers may prefer to engage with customers having an expected life time value (LTV) falling within a specified range. In this case the service provider profile includes an expected LTV tolerance. Only users with an expected LW according with the preference of the insurance provider will be matched. This list of service provider preferences is not intended to be exhaustive. The factors listed are only intended as examples of the types of preferences and considerations that may contribute to creating the service provider profiles, and do not limit the invention to the specific examples. Each insurance provider may have different subsets of factors and preferences that contribute to the corresponding service provider profile.

Server 202 executes matching engine 232 to match at least one user to at least one service provider based on the enhanced user profile of the at least one user, and the service provider profiles of the service providers. Any suitable technique may be applied for the matching, such as machine learning, artificial intelligence, statistical regression, correlation and curve fitting, and the like. For example, in addition to service type, speed, timing and price, matching may be based on the probability that the user will defraud the service provider, age attributes, health attributes, the intent of the user, the probability that the user will purchase a service, the probability that the engagement will result in a conversion via a fully online process that does not require assistance of a human agent, and the like.

For example, form completion time may affect the probability of fraud, or may lead to inferences about age, health, user intent, the probability of the user purchasing a service, and achieving a conversion via a fully online process. As another example, a slower than average typing speed and/or the user device type may affect the probability of fraud, and lead to inferring the age of the user. Similarly, properties relating to the communication channel may lead to inferring the age of the user. A longer than average time to answer specific questions may trigger an alert of a potential for fraud. Alternatively, a longer than average response time may lead to inference over the intent of the user, and the ability to achieve a conversion via a fully online process.

In the example of FIG. 2A, the user of user device 204_n is matched by server 202 with the service provider of service provider device 206_m based on the respect enhanced user profile and service provider profile. Server 202 establishes channel 210 connecting user device 204_n with service provider device 206_m to enable direct communication between the respective user and service provider. Server 202 additionally provides service provider device 206_m with one or more aspects of the user profile of the matched user, such as a higher risk factor related to the health and age of the user, as well as an anomaly detected from the information entered by the user.

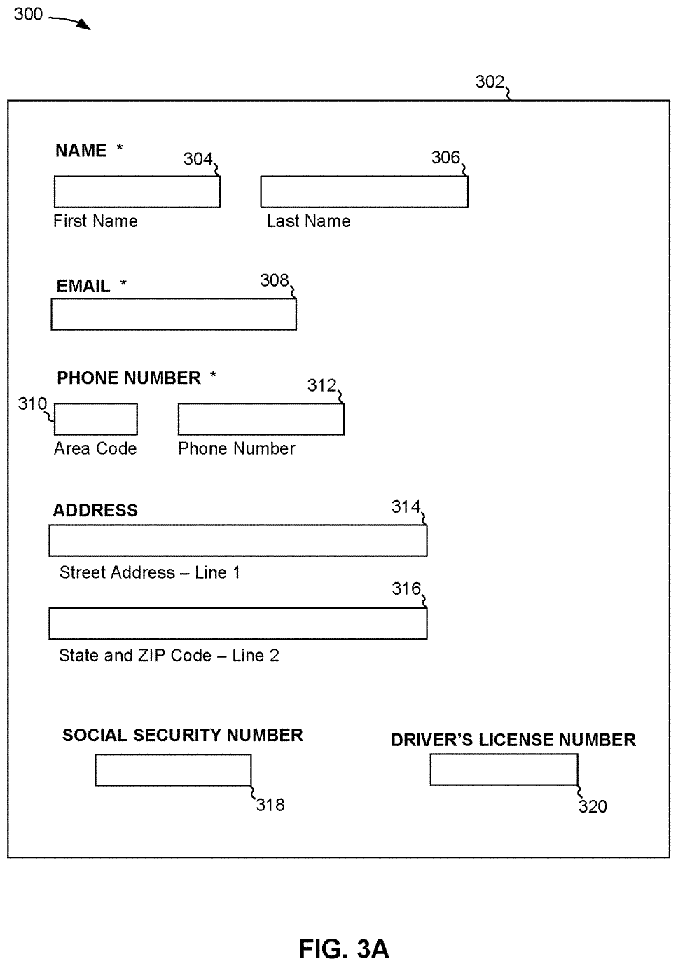

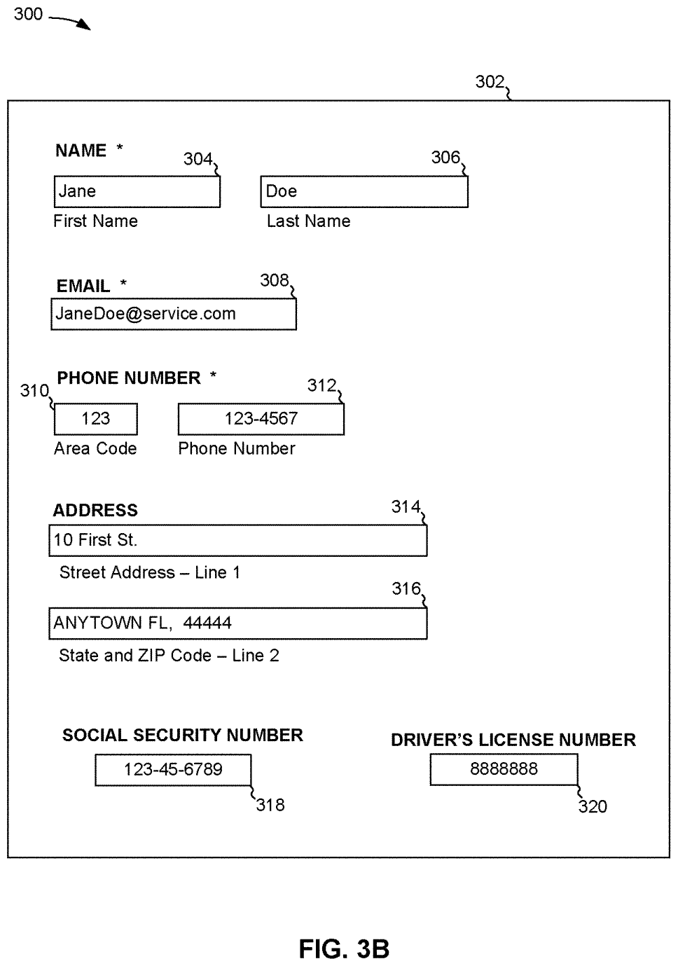

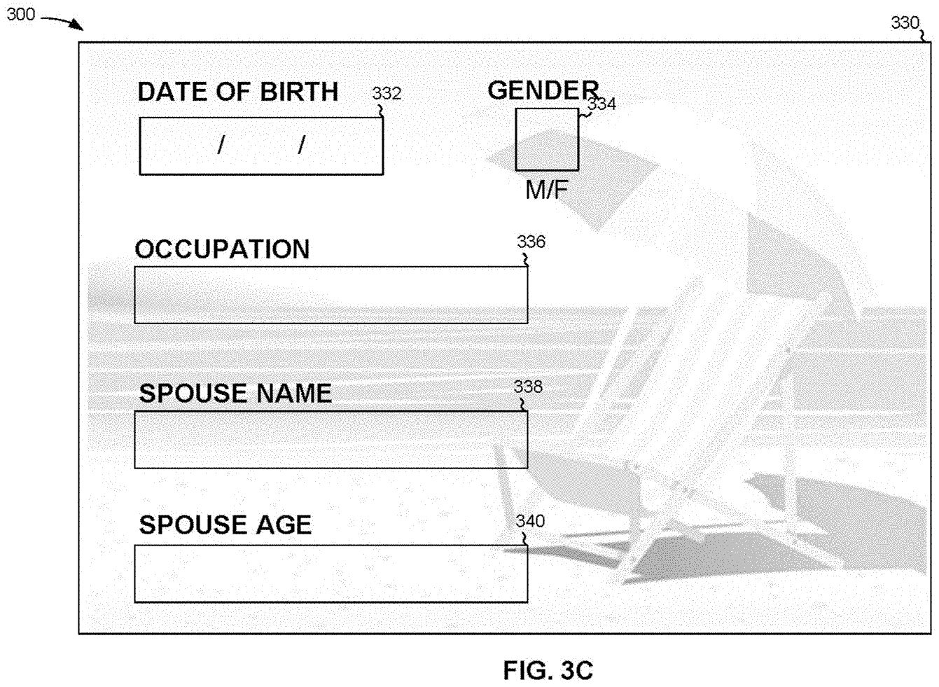

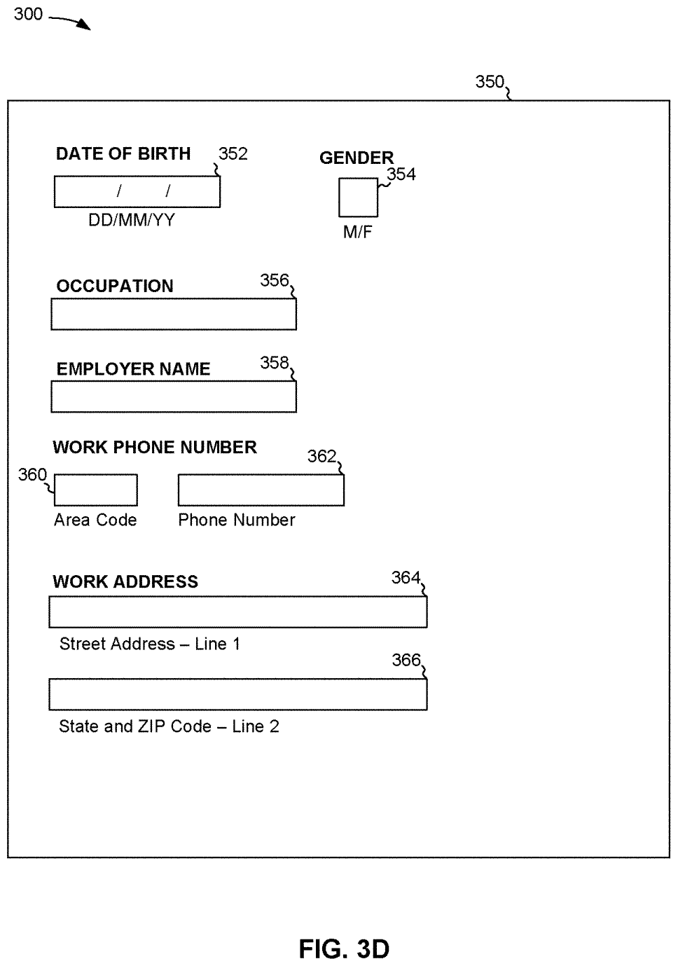

Reference is now made to FIGS. 3A-3D, which taken together, are a schematic illustration of an exemplary dynamically adaptive display-based user interface (UI), generally referenced 300, for collecting information from a user to create a user profile, constructed and operative in accordance with another embodiment of the disclosed technique. FIG. 3A shows a blank, first electronic form 302 of dynamically adaptive UI 300, such as may be presented by server 202 to the users of devices 204_1 and 204_n (FIG. 2A).

FIG. 3B shows first electronic form 302 after the user has entered data into the fields. Server 202 derives a user characteristic based on the response of the user. Server 202 applies the user characteristic to dynamically modify a display property for a follow-up electronic form to display to the user (e.g. of device 204_n).

FIG. 3C shows a follow-up electronic form 330 prompting the user of device 204_n to enter additional information, with one or more display properties modified accordingly, to facilitate the continued engagement. The modification is beneficial in enabling server 202 to collect additional information from the user and create an enhanced user profile. The enhanced user profile includes more information than a typical user profile based only on the message content of the data received in response to prompts. Server 202 subsequently uses the enhanced user profile to match the user with one of multiple service providers.

FIG. 3D shows a contrasting follow-up electronic form 370 that may be displayed to a different user (e.g. the user of device 204_1). The display properties of follow-up electronic form 350 differ from those of follow-up electronic form 330 due to the different user characteristics. For example, based on information collected along the information vectors for the user of device 204_n, server 202 infers that the user is retired and has difficulty reading small text. Server 202 has modified follow-up form 330 accordingly to suit the characteristics of the user of device 204_n. Conversely, based on information collected along the information vectors for the user of device 204_1, server 202 infers that this user is employed and can easily read small text. Thus, server 202 displays follow-up form 350 with more text, and formats the text using a smaller font. The arrangement, layout and content of the fields, the font size, and the background for follow-up electronic form 350 differ than those of electronic form 330, to suit the users of devices 204_n and 204_1, respectively.

With reference to FIG. 3A, first electronic form 302 of dynamically adaptive UI 300 for displaying to a user is shown. First electronic form 302 may be presented to both users of devices 204_n and 204_1. First electronic form 302 presents multiple fields for receiving information from the user, such as First Name 304, Last Name 306, Email 308, Area code 310, Phone number 312, first Address line 314, second Address line 316, Social Security 318 and Driver's License 320. Server 202 displays first electronic form 302 on client devices 204_1 . . . 204_n prompting the respective user to enter information into the displayed fields.

Referring to FIG. 3B, first electronic form 302 of dynamically adaptive UI 300 is shown after the user of client device 204_n has responded by entering information into fields 304-320. Server 202 derives one or more user characteristics pertaining to the user based on data collected from the user along multiple information vectors.

Server 202 determines from the number of typos and typing speed of the user, that the user has difficulty reading the text displayed in first electronic form 302. Additionally, server 202 determines that the address entered by the user is associated with a retirement community, and the user is a retiree. Moreover, since the address is in proximity to the sea, server 202 determines that the user enjoys a sea view.

Server 202 applies the user characteristic to dynamically modify a display property for the follow-up electronic form in a manner to accommodate the user's needs and preferences and facilitate continued engagement. The modified display property make for a more pleasant and personalized experience for the user with UI 300, allowing server 202 to collect more information. Server 202 may modify any suitable display properties, such as the font size; font type; font style; background color; background texture; background context; display orientation; content of the follow-up form; an image attribute for an image displayed with the follow-up form, such as the size, style, content, color, brightness, saturation, resolution, and context, selected to appeal to the user, to name but a few.

With reference to FIG. 3C, follow-up form 330 of UI 300 is displayed to the user of device 204_n, with the modifications made to one or more display properties. The font size of follow-up form 330 is larger than for first electronic form 302 to facilitate the readability for someone with difficulty reading small text. To accommodate the larger text, server 202 elects to display fewer fields via follow-up form 330 than would have been displayed without the modification (e.g. as compared to follow-up form 350 of FIG. 3D). Since the user is assumed to be a retiree, server 202 elects to remove fields relating to employment. Server 202 additionally displays beach scenery in the background of follow-up form 330 to appeal to the user and encourage the continued engagement with UI 300. Server 202 determines that the device used by the user (e.g. device 204_n of FIG. 2A) is a hand-held device, and therefore has a relatively small screen. To accommodate the larger font and beach scenery in the background, server 202 displays follow-up form 330 in a landscape orientation. Accordingly, follow-up form 330 displays a birth date field 332, a gender field 334, an occupation field 336, a spouse name 338, and a spouse age 340. The headers for fields 332-340 are formatted in a larger and bolder font than for fields 304-320 of first electronic form 302. The background of follow-up form 330 is a pleasant beach view to appeal to the user of device 204_n, who lives near the beach.

Additional modifications may include displaying scenery from the user's neighborhood in the background if the user is looking to purchase home insurance, or displaying an image of the user's car if the user is looking to purchase car insurance. As a further example, a ski scene in the background of a follow-up form for a user seeking travel insurance for a ski holiday. Images may be displayed as part of the background or in the foreground to embellish the electronic form.

With reference to FIG. 3D, a second follow-up form 350 is displayed for the user of device 204_1 (FIG. 2A). Server 202 selects the display properties for second follow-up form 350 to accommodate the characteristics of the user of device 204_1, which are different than the characteristics of the user of device 204_n. For example, based on the interaction with the user of device 204_1, server 202 determines that this user is employed and has no difficulty reading smaller text. Therefore, follow-up form 350 includes fields related to employment that were omitted from follow-up form 330, e.g. employer name 358, work area code 360, work phone number 362, work address line 1 364 and work address line 2 366. The device type detected for user device 204_1 is a desktop computer, which typically has a larger screen. The headers of fields 352-366 are formatted in the same manner as for first electronic form 302, i.e. in a smaller font to allow fitting all the fields in one form.

The examples described herein are intended to illustrate possible types of dynamic modifications that server 202 makes to UI 300 to suit the needs and preferences of each user, and are not intended to be limiting. The technique may be similarly applied to different graphical layouts, for example instead of typing in information, the UI may be touch-based or click-based.

In some embodiments, server 202 additionally deploys an automated agent of audio-based UI 226 to engage with a user in a conversation. The automated agent generates an audio stream which server 202 provides to the user (e.g. device 204_n) over network 208. Device 204_n plays the audio stream prompting the user to respond vocally. Server 202 receives the vocal response and derives from it additional user characteristics, such as from a word enunciation rate, volume, tone, background noise, a detected accent, gender or age, and the like.

Server 202 applies the user characteristic to dynamically modify an audio property of a follow-up audio stream. The modified audio property is configured to facilitate the continued engagement of the user with the automated agent. For example, server 202 may modify the message content of the follow-up audio stream, the volume level, the word enunciation rate, the pitch, the tone, the gender, age, or accent in a manner to appeal to the user and encourage continued engagement. Server 202 provides the modified follow-up audio stream generated by the automated agent to device 204_n over network 208. Device 204_n plays the modified audio, prompting the user to respond. The user provides a second voice response, which is used by server 202 to derive additional user characteristics. The user characteristics derived by server 202 are applied along with the user characteristics determined via display-based UI 300 to create the user profile.

Once enough information has been collected and the user profile is sufficiently enhanced, server 202 matches the user with at least one of the service providers based on the enhanced user profile and the service providers profiles. Server 202 prompts the user to confirm the match. On receiving a confirmation, server 202 connects the user with the matched service provider. For example, server 202 connects user device 204_n with service provider device 206_m by establishing channel 210 between the respective devices, based on the match between the user profile associated with user device 204_n and the service provider profile associated with service provider device 206_m. Server 202 additionally provides to service provider device 206_m at least one aspect of the user profile created for the user of device 204_n. This is to facilitate an agreement between the user and the matched service provider.

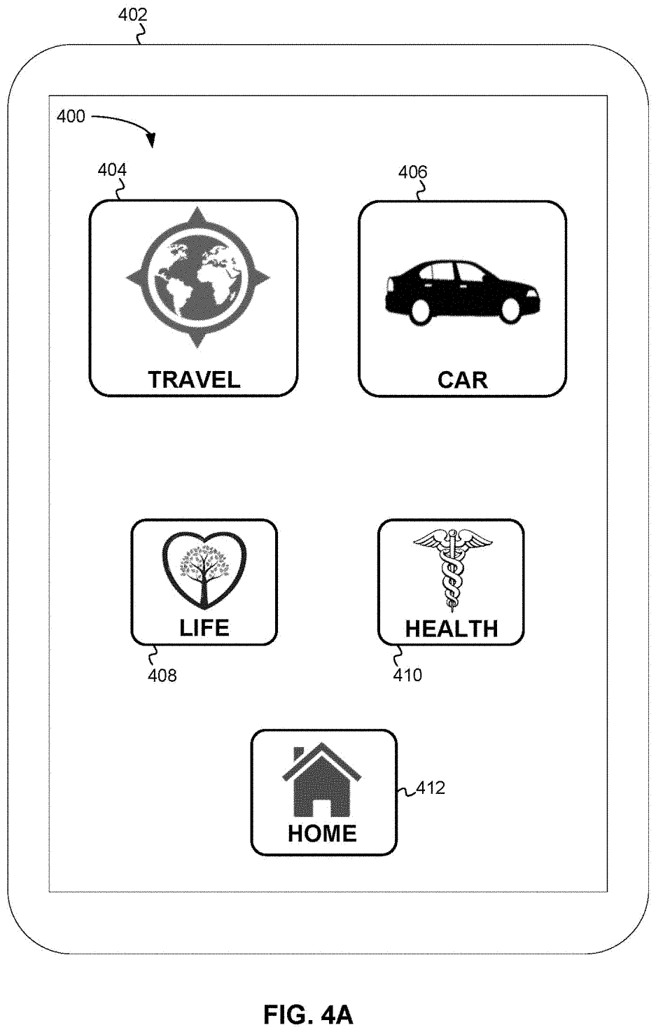

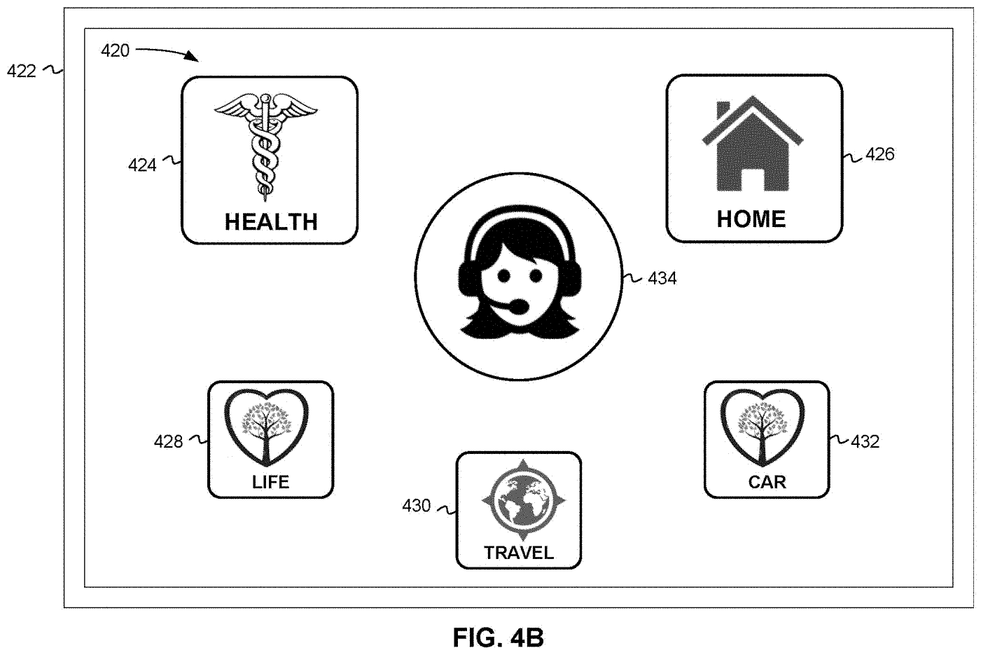

Reference is not made to FIGS. 4A-4B, which taken together, illustrate another exemplary implementation of an adaptive UI, constructed and operative in accordance with another embodiment of the disclosed technique. FIG. 4A illustrates an online form 400 displayed on a device 402 for acquiring information from a first user, and FIG. 4B illustrates an online form 420 displayed on a device 422 for acquiring information from a second user. Devices 402 and 422 may correspond to any of user devices 204_1 . . . 204_n of FIG. 2A.

Referring to FIG. 4A, after an initial engagement with the first user, server 202 determines that device 402 is a handheld device targeted to young people interested in playing online games and engaging in social media. Server 202 additionally determines that device 402 is currently located in a college pub frequented by students. Based on the location and device type, server 202 infers that the first user is a college student who is probably more interested in travel and car insurance than home, health or life insurance. Server 202 modifies online form 400 to suit the inferred interests and needs of the first user, and displays online form 400 on device 402 via dynamic UI 222. Thus, buttons 404 and 406 for selecting travel and car insurance, respectively, are displayed larger and in a more prominent location on the screen of device 402 (e.g. towards the top). Buttons 408, 410, and 412 for selecting life, health and home insurance, respectively, are displayed smaller and less prominently on the screen of device 402 (e.g. towards the bottom). Due to the location (noisy pub) and characteristics of the first user (young adult familiar with technology), server 202 infers that the first user can probably reach a conversion to a binding agreement via a fully online process without needing additional assistance.

Turning to FIG. 4B, after an initial engagement with the second user, server 202 determines that device 422 is a relatively old model of a desktop computer. Server 202 additionally determines that device 422 is located in a library of a community center serving senior citizens. Based on the location and device type, server 202 infers that the second user is a senior citizen who is probably more interested in health and home insurance than travel, car or life insurance. Moreover, due to the characteristics of the second user (senior and less familiar with technology), server 202 infers that the second user could probably benefit from assistance from a human or automated agent to complete subsequent forms. Accordingly, server 202 modifies online form 420 to suit the inferred interests and needs of the second user. Server 202 displays the modified form 420 on device 422 via dynamic UI 222. Buttons 424 and 428 for selecting health and home insurance, respectively, are displayed larger and in a more prominent location on the screen of device 422 (e.g. towards the top). Button 434 offering the second user online assistance via an audio agent (human or automated) is displayed prominently in the center of form 420. Buttons 428, 430, and 432 relating to travel, car and life insurance, respectively, are displayed smaller and less prominently on the screen of device 422 (e.g. towards the bottom). Thus, based on the characteristics derived for each user, server 202 modifies the form presented to each user to suit the specific needs and goals to improve the user experience and encourage continued engagement.

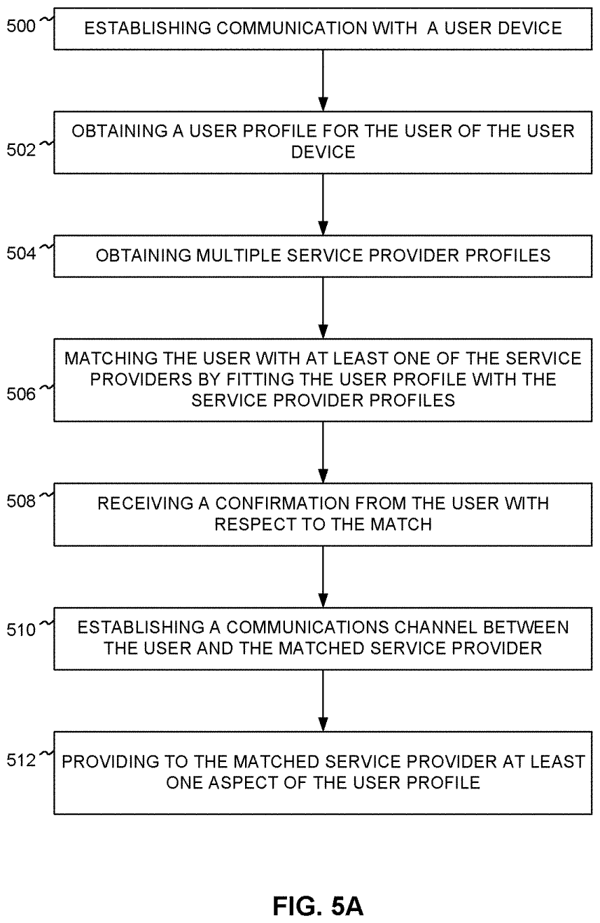

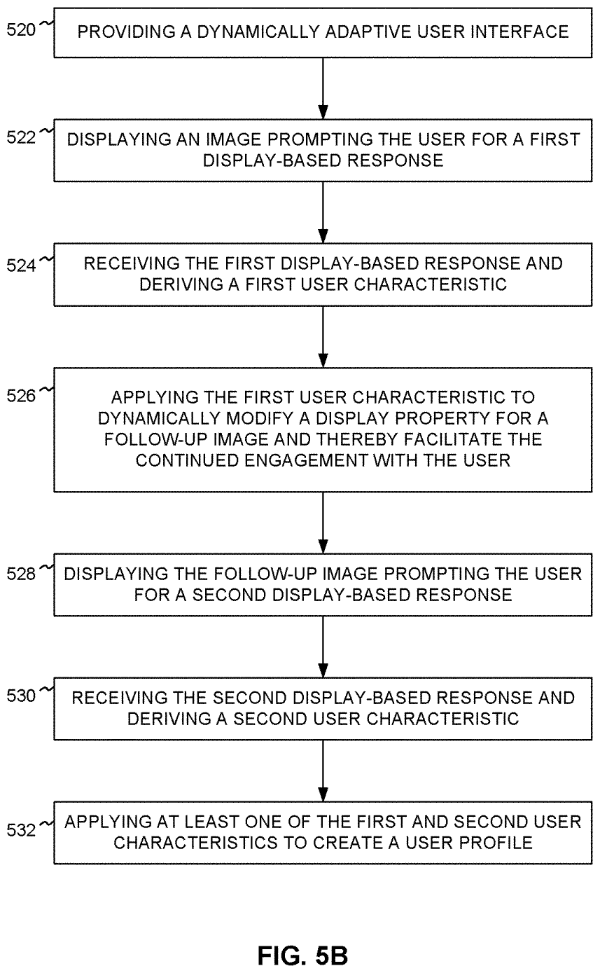

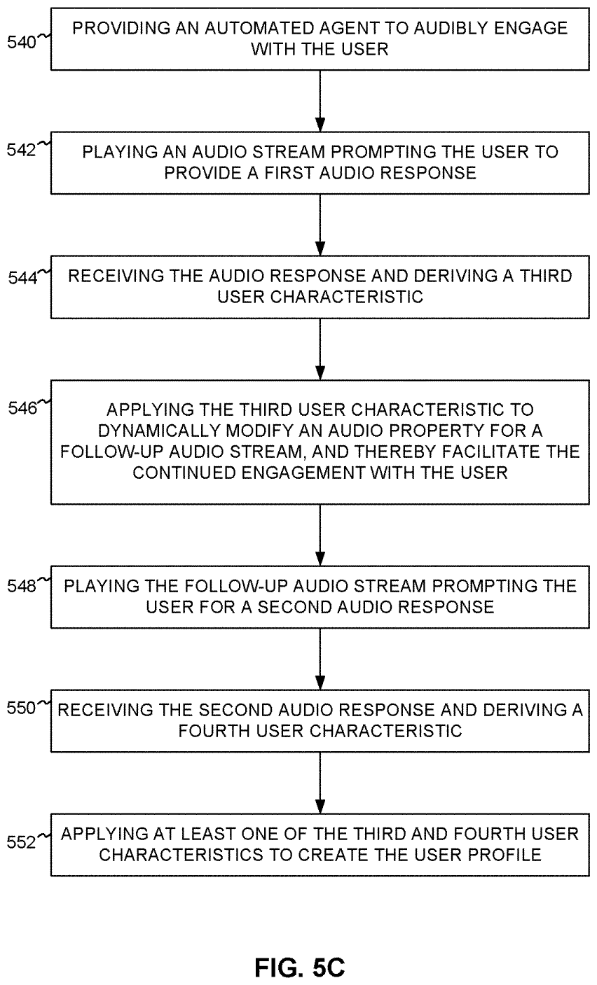

Reference is now made to FIG. 5A, which is a flowchart of a method matching a user to one of multiple candidate service providers, constructed and operative in accordance with a further embodiment of the disclosed technique.

In procedure 500, communication is established with a user via a user device. With reference to FIG. 2A, server 202 establishes communication with user device 204_n over network 208.

In procedure 502, a user profile associated with the user is obtained. With respect to FIGS. 2A-2B, server 202 deploys dynamically adaptive UI 222 to obtain information about the user. Server 202 deploys user profile builder 228 to apply the information and create the user profile. The user profile may include any of: a sought service type, quality, speed, a risk niche, demographic niche, socio-economic niche, an age attribute, a health attribute, a quote acceptance likelihood, a binding likelihood, an expected life time value, a probability of fraud, the user's intent, and a probability of converting the interaction to a binding agreement via a fully online process, and the like.

In some embodiments, the user profile is created by collecting information about the user along multiple information vectors. The information vectors may include one or more of: the behavior of the user while engaging with the adaptive UI, a hardware or software configuration of the user device, the user device type, a characteristic of the communication channel, a bandwidth rate, a geographic location of the user device, a location type associated with the geographic location, an ad vector facilitating the engaging with the user, a search query facilitating the engaging with the user, a time or date of the engagement in the interactive communication, and an anomaly associated the user.

In procedure 504, multiple service provider profiles are obtained. With respect to FIGS. 2A-2B, server 202 communicates with service providers 206_1 . . . 206_n over network 208. Server 202 acquires information about the service providers of respective devices 206_1 . . . 206_n, either directly from the service providers, or indirectly from surveys, reports, and the like. Server 202 deploys service provider profile builder 230 to create service provider profiles for each service provider of respective devices 206_1 . . . 206_n. The service provider profile may include one or more of: an offered service type, an offered service quality, an offered service speed, a target risk niche, a target demographic niche, a target socio-economic niche, a quote acceptance threshold, a binding threshold, and an expected user life time value threshold, and the like.

In procedure 506, the user is matched with one of multiple service providers by fitting at least one factor of the user profile with at least one factor of at least one of the multiple service provider profiles. With reference to FIG. 2A, server 202 matches the user of user device 204_n with the service provider associated with service provider device 206_m by fitting at least one factor of the user profile, e.g. the socio-economic niche, to the target socio-economic niche of the service provider profile.

In procedure 508, a confirmation is received from the user with respect to the matching. With reference to FIG. 2A, server 202 requests from the user of device 204_n a confirmation if the user consents to the match made with the service provider of service provider device 206_m. Server 202 receives the confirmation from the user of user device 204_n.

In procedure 510, a communication channel is established between the user and the matched one of the multiple service providers. With respect to FIG. 2A, server 202 establishes channel 210 between user device 204_n and service provider device 206_m over network 208.

In procedure 512, the matched one of the multiple service providers, is provided with at least one aspect of the user profile. With respect to FIG. 2A, server 202 provides at least one aspect of the user profile for the user of user device 204_n to service provider device 206_m over network 208. For example, server 202 provides the service provider with a risk of fraud assessment based on an anomaly detected during the user's interaction with adaptive UI 222.

Reference is now made to FIG. 5B which is a flowchart of a method for creating a user profile via a dynamically adaptive user interface (UI), constructed and operative in accordance with a further embodiment of the disclosed technique. The method of FIG. 4B may be used in conjunction with the method of FIG. 5A.

In procedure 520, an adaptive user interface (UI) configured to at least visually engage in an interactive communication with a user is provided. With reference to FIGS. 2A and 3A, server 202 provides an adaptive user interface 300 to user devices 204_1 . . . 204_n over network 208 to visually engage in an interactive communication with the respective users of user devices 204_1 . . . 204_n.

In procedure 522, an image prompting the user to provide a first response is displayed via the adaptive UI. With reference to FIG. 3A, electronic form 302 prompts a user (e.g. of device 204_n of FIG. 2A) to provide a first response.

In procedure 524, the first response is received. A first user characteristic based on at least one of multiple information vectors associated with the user is derived. The multiple information vectors include at least the first response of the user. With reference to FIG. 3B, the user enters data into fields 304-320 of electronic form 302. Server 202 (FIG. 2A) receives the response from user device 204_n and derives a user characteristic based on at least one information vector associated with the user. For example, server 202 determines from the location of device 204_n, the device type of device 204_n, the home address entered by the user of device 204_n, and behavioral characteristics of the user while entering data into form 302, that the user is a retiree who uses a handheld device, has difficulty seeing small print, and lives near the sea.

In procedure 526, the first user characteristic is applied to dynamically modify a display property of a follow-up image prompting the user for a second response via the adaptive UI. The modified display property is configured to facilitate the engagement with the user via the adaptive UI. With reference to FIG. 3C, server applies the user characteristic to dynamically modify several display properties of follow-up electronic form 330, such as by increasing the font size, omitting fields relating to employment, displaying a beach scene in the background, and adjusting the orientation of the display to landscape. By comparison, FIG. 3D shows a corresponding follow-up form 350 without any modifications.

In procedure 528, the follow-up image is displayed via the adaptive UI. With reference to FIG. 3C, follow-up form 330 is displayed on device 204 via adaptive UI 300.

In procedure 530, the second response is received and deriving a second user characteristic for the user based on the second response. With reference to FIG. 3C, the user enters data into fields 332-340. Server 202 receives the data and derives from the data a second user characteristic, such as the fact that the user is married.

In procedure 532, at least one of the first and user characteristics are applied to create an enhanced user profile for the user. With reference to FIG. 2B, user profile builder 228 uses at least one of the first and second user characteristics to create the enhanced user profile for the user of device 204_n.

In some embodiments, the multiple information vectors include one or more of: the adaptive UI, the behavior of the user while engaging with the adaptive UI, the hardware configuration of the user device, including the device type and the bandwidth rate, the geographic location of the user device and the location type, an ad vector facilitating the engagement with the user, a search query facilitating the engagement with the user, and an anomaly associated with the user.

In some embodiments, the behavioral of the user while engaging with the adaptive UI is associated with one or more of: a data entry rate, a delay, an error rate, an error type, and use of an auto-fill tool.

In some embodiments, the modified display property is one or more of: a font size, a font style, a font color, a background color, a background texture, a background context, a display orientation, a content characteristic, an image size, an image style, an image color, an image brightness, an image saturation, an image resolution, and an image context.

Reference is now made to FIG. 5C which is a flowchart of a method for creating a user profile via a dynamically adaptive user interface (UI), constructed and operative in accordance with another embodiment of the disclosed technique. The method of FIG. 5C may be used in conjunction with any of the methods of FIGS. 5A-5B.

In procedure 540, an automated agent configured to audibly engage in a conversation with the user is provided. With respect to FIGS. 2A-2B, server 202 deploys an automated agent provided by audio-based UI 226 to audibly engage in a conversation with the users of devices 204_1 . . . 204_n over network 208.

In procedure 542, an audio stream prompting the user to provide a first voice response is played via the automated agent. With reference to FIGS. 1A and 2A, speaker 120 plays the audio stream, prompting the user of device 204_n to provide a first voice response.

In procedure 544, the first voice response is received and a third user characteristic for the user is derived based on the first voice response. With reference to FIGS. 1A and 2A, microphone 118 detects the voice response of the user. Server 202 receives the detected voice response from device 204_n over network 208 and derives a third user characteristic. The third user characteristic may be derived from one or more of the message content of the first voice response, the word enunciation rate, the volume, the pitch, the tone, or the regional accent of the first voice response, the gender or age of the user determined from the first voice response, and the like. For example, based on the tone of the user, server 202 determines that the user is hard of hearing.

In procedure 546, the third user characteristic is applied to dynamically modify an audio property of a follow-up audio stream prompting the user for a second voice response. The modified audio property is configured to facilitate the engagement with the user via the automated agent. With reference to FIGS. 2A-2B, server 202 increases the volume for a follow-up audio stream prompting the user of device 204_n for a second voice response. The increased volume is intended to facilitate the conversation between the user of device 204_n and the automated agent. Additionally or alternatively, the word enunciation rate, pitch, tone, gender characteristic, age characteristic, or accent may be modified to facilitate engagement.

In procedure 548, the follow-up audio stream is played via the automated agent. With reference to FIGS. 1A and 2A, speaker 120 plays the follow-up audio stream, prompting the user of device 204_n to provide the second voice response.

In procedure 550, the second voice response is received and a fourth user characteristic based on the second voice response is derived. With reference to FIGS. 1A and 2A, microphone 118 senses the second vocal response of the user. Server 202 receives the second voice response from device 204_n over network 208 and derives a fourth user characteristic, e.g. that the user prefers engaging with audio-based UI 226 over display-based UI 224.

In procedure 552, at least one of the third and fourth user characteristics are applied to create the enhanced user profile for the user. With reference to FIGS. 2A-2B, server 202 deploys user profile builder 228, which applies at least one of the third and fourth user characteristics to create the enhanced user profile for the user. For example, the characteristics that the user is elderly and prefers engaging with audio-based UI 226 may indicate a preference for a premium level of service from the service provider.

In some embodiments, the third and fourth user characteristics are based on any of: a word enunciation rate, a regional accent, a gender of the user, and an age of the user.

In some embodiments, the modified audio property is one or more of: message content for the follow-up audio stream, a volume level, a word enunciation rate, a pitch, a tone, a gender characteristic, an age characteristic, and an accent characteristic.

It will be appreciated by persons skilled in the art that the disclosed technique is not limited to what has been particularly shown and described hereinabove. Rather the scope of the disclosed technique is defined only by the claims, which follow.

What is claimed is:

1. A method for matching a user to a service provider, the method comprising:
communicating with a user via a user device;
obtaining a user profile associated with said user, said user profile based on at least one factor selected from the group consisting of: a sought service type, a sought service quality, a sought service speed, a risk niche, a demographic niche, a socio-economic niche, an age attribute, a health attribute, a quote acceptance likelihood, a binding likelihood, an expected life time value, a probability of fraud, user intent, and a probability of conversion via a fully online process;
obtaining multiple service provider profiles, each associated with a different provider for a service, wherein each service provider profile is based on at least one factor selected from the group consisting of: an offered service type, an offered service quality, an offered service speed, a target risk niche, a target demographic niche, a target socio-economic niche, a quote acceptance threshold, a binding threshold, and an expected user life time value threshold;
matching said user with at least one of said multiple service providers by fitting at least one factor of said user profile to at least one factor of at least one of said multiple service provider profiles;
presenting said matched one of said multiple service providers to said user;
receiving a confirmation from said user regarding said matched one of said multiple service providers;
establishing a channel between said user and said matched one of said multiple service providers; and
providing at least one aspect of said user profile to said matched one of said multiple service providers.

2. The method of claim 1, further comprising creating said user profile by:
providing an adaptive user interface (UI) configured to at least visually engage in an interactive communication with said user;
displaying on said user device, via said adaptive UI, an image prompting said user to provide a first response;
receiving said first response via said adaptive UI;
deriving a first user characteristic based on at least one of multiple information vectors associated with said user, said multiple information vectors comprising at least said adaptive UI;
applying said first user characteristic to dynamically modify a display property of a follow-up image prompting said user for a second response via said adaptive UI,
wherein said modified display property is configured to facilitate said engagement with said user via said adaptive UI;
displaying said follow-up image via said adaptive UI;
receiving said second response;
deriving a second user characteristic for said user based on said second response; and
applying at least one of said first user characteristic and said second characteristic to create a user profile for said user.

3. The method of claim 2, wherein said multiple information vectors further comprise a vector selected from the group consisting of: a behavior of said user while engaging with said adaptive UI, a hardware configuration of said user device, a software configuration of said user device, a type of said user device, a characteristic of said communication channel, a bandwidth rate, a geographic location of said user device, a location type associated with said geographic location, an ad vector facilitating said engaging with said user, a search query facilitating said engaging with said user, a time of said visually engaging in said interactive communication, a date of said visually engaging in said interactive communication, and an anomaly associated with said user.

4. The method of claim 3, wherein said behavior is selected from the group consisting of: a data entry rate, a delay, an error rate, an error type, and use of an auto-fill tool.

5. The method of claim 2, wherein said modified display property is selected from the group consisting of: a font size, a font style, a font color, a background color, a background texture, a background context, a display orientation, a content characteristic, an image size, an image style, an image color, an image brightness, an image saturation, an image resolution, and an image context.

6. The method of claim 2, further comprising:
providing an automated agent configured to audibly engage in a conversation with said user,
playing, via said automated agent, an audio stream prompting said user to provide a first voice response,
receiving said first voice response,
deriving a third user characteristic for said user based on said first voice response, and
applying said third user characteristic to dynamically modify a property of at least one of a follow-up audio stream and a second follow-up image, wherein said modified property is configured to facilitate said engaging with said user.

7. The method of claim 6, wherein said dynamically modified property is of said follow-up audio stream, said property selected from the group consisting of: a message content, a volume level, a word enunciation rate, a pitch, a tone, an accent, a gender characteristic, an age characteristic, and an accent characteristic.

8. The method of claim 6, further comprising playing said follow-up audible stream via said automated agent,
receiving a second voice response to said follow-up audible stream,
deriving a fourth user characteristic for said user based on said second voice response, and
applying at least one of said third user characteristic and said fourth characteristic to create said user profile for said user.

9. The method of claim 8, wherein deriving any of said third user characteristic and said fourth user characteristic comprises deriving based on an attribute of at least one of said first voice response and said second voice response, said attribute selected from the group consisting of: a message content, a word enunciation rate, a volume, a pitch, a tone, an accent, a gender characteristic, and an age characteristic.

10. The method of claim 1, further comprising creating said multiple service provider profiles corresponding to each of said multiple service providers.

11. A system for matching a user to a service provider, the system comprising:
a communication network; and
a server computing device comprising at least one server-side processor, said server side computing device configured to communicate with multiple user devices and multiple service provider devices via a communication channel of said communication network,
wherein said at least one server-side processor is configured to:
obtain a user profile associated with said user, said user profile based on at least one factor selected from the group consisting of: a sought service type, a sought service quality, a sought service speed, a risk niche, a demographic niche, a socio-economic niche, an age attribute, a health attribute, a quote acceptance likelihood, a binding likelihood, an expected life time value, a probability of fraud, user intent, and a probability of conversion via a fully online process;
obtain multiple service provider profiles, each associated with a different provider for a service, wherein each service provider profile based on at least one factor selected from the group consisting of: an offered service type, an offered service quality, an offered service speed, a target risk niche, a target demographic niche, a target socio-economic niche, a quote acceptance threshold, a binding threshold, and an expected user life time value threshold;
match said user with at least one of said multiple service providers by fitting at least one factor of said user profile to at least one factor of at least one of said multiple service provider profiles;
present said matched one of said multiple service providers to said user;
receive a confirmation from said user regarding said matched one of said multiple service providers;
establish a channel between said user and said matched one of said multiple service providers; and
provide at least one aspect of said user profile to said matched one of said multiple service providers.

12. The system of claim 11, wherein said server-side processor is further configured to create said user profile by:
providing an adaptive user interface (UI) configured to at least visually engage in an interactive communication with said user;
displaying on said user device, via said adaptive UI, an image prompting said user to provide a first response;
receiving said first response via said adaptive UI;
deriving a first user characteristic based on at least one of multiple information vectors associated with said user, said multiple information vectors comprising at least said adaptive UI;
applying said first user characteristic to dynamically modify a display property of a follow-up image prompting said user for a second response via said adaptive UI,
wherein said modified display property is configured to facilitate said engagement with said user via said adaptive UI;
displaying said follow-up image via said adaptive UI;
receiving said second response;
deriving a second user characteristic for said user based on said second response; and
applying at least one of said first user characteristic and said second characteristic to create a user profile for said user.

13. The system of claim 12, wherein said multiple information vectors further comprise a factor selected from the group consisting of: a behavior of said user while engaging with said adaptive UI, a hardware configuration of said user device, a software configuration of said user device, a type of said user device, a characteristic of said communication channel, a bandwidth rate, a geographic location of said user device, a location type associated with said geographic location, an ad vector facilitating said engaging with said user, a search query facilitating said engaging with said user, a time of said visually engaging in said interactive communication, a date of said visually engaging in said interactive communication, and an anomaly associated with said user.

14. The system of claim 13, wherein said behavior is selected from the group consisting of: a data entry rate, a delay, an error rate, an error type, and use of an auto-fill tool.

15. The system of claim 12, wherein said modified display property is selected from the group consisting of: a font size, a font style, a font color, a background color, a background texture, a background context, a display orientation, a content characteristic, an image size, an image style, an image color, an image brightness, an image saturation, an image resolution, and an image context.

16. The system of claim 12, wherein said adaptive UI further includes an audio-based UI equipped with an automated agent configure to:
audibly engage in a conversation with said user by:
playing an audio stream prompting said user to provide a first voice response, and
receive said first voice response,
wherein said computing device is further configured to derive a third user characteristic for said user based on said first voice response, and
apply said third user characteristic to dynamically modify a property of said adaptive UI relating to at least one of a follow-up audio stream and a second follow-up image, wherein said modified property is configured to facilitate said engaging with said user.

17. The system of claim 16, wherein said modified property relates to said follow-up audio stream, said property selected from the group consisting of: a message content, a volume level, a word enunciation rate, a pitch, a tone, an accent, a gender characteristic, an age characteristic, and an accent characteristic.

18. The system of claim 16, wherein said automated agent is further configured to play said follow-up audible stream and receive a second voice response to said follow-up audible stream,
wherein said computing device is configured to derive a fourth user characteristic for said user based on said second voice response, and apply at least one of said third user characteristic and said fourth characteristic to create said user profile.

19. The system of claim 18, wherein said third user characteristic and said fourth user characteristic are derived based on an attribute of at least one of said first voice response and said second voice response, said attribute selected from the group consisting of: a message content, a word enunciation rate, a volume, a pitch, a tone, an accent, a gender characteristic, and an age characteristic.

20. The system of claim 12, wherein said at least one server-side processor is further configured to create said multiple service provider profiles corresponding to each of said multiple service providers.

21. A method for creating a user profile via a dynamically adaptive user interface (UI), the method comprising the procedures of:
providing an adaptive user interface (UI) configured to at least visually engage in an interactive communication with a user via a user device;
displaying on said user device, via said adaptive UI, an image prompting said user to provide a first response;
receiving said first response via said adaptive UI;
deriving a first user characteristic based on at least one of multiple information vectors associated with said user, said multiple information vectors comprising at least said adaptive UI;
applying said first user characteristic to dynamically modify a display property of a follow-up image prompting said user for a second response via said adaptive UI,
wherein said modified display property is configured to facilitate said engagement with said user via said adaptive UI;
displaying said follow-up image on said user device via said adaptive UI;
receiving said second response via said adaptive UI;
deriving a second user characteristic for said user based on said second response; and
applying at least one of said first user characteristic and said second characteristic to create a user profile for said user.

22. The method of claim 21 wherein said user profile is based on at least one factor selected from the group consisting of: a sought service type, a sought service quality, a sought service speed, a risk niche, a demographic niche, a socio-economic niche, an age attribute, a health attribute, a quote acceptance likelihood, a binding likelihood, an expected life time value, a probability of fraud, user intent, and a probability of conversion via a fully online process.

23. The method of claim 21, wherein said multiple information vectors further comprise a vector selected from the group consisting of: a behavior of said user while engaging with said adaptive UI, a hardware configuration of said user device, a software configuration of said user device, a type of said user device, a characteristic of a communication channel used by said user device, a bandwidth rate of said communication channel, a geographic location of said user device, a location type associated with said geographic location, an ad vector facilitating said engaging with said user, a search query facilitating said engaging with said user, a time of said visually engaging in said interactive communication, a date of said visually engaging in said interactive communication, and an anomaly associated with said user.

24. The method of claim 23, wherein said behavior is selected from the group consisting of: a data entry rate, a data entry delay, a data entry error rate, a data entry error type, and use of an auto-fill tool.

25. The method of claim 21, wherein said modified display property is selected from the group consisting of: a font size, a font style, a font color, a background color, a background texture, a background context, a display orientation, a display content characteristic, an image size, an image style, an image color, an image brightness, an image saturation, an image resolution, an image opacity, and an image context.

26. The method of claim 21, further comprising:
providing an automated agent configured to audibly engage in a conversation with said user via said user device,
playing on a speaker of said user device, via said automated agent, an audio stream prompting said user to provide a first voice response,
receiving said first voice response,
deriving a third user characteristic for said user based on said first voice response, and
applying said third user characteristic to dynamically modify a property of at least one of a follow-up audio stream and a second follow-up image, wherein said modified property is configured to facilitate said engaging with said user.

27. The method of claim 26, further comprising:
playing said follow-up audible stream via said automated agent,
receiving a second voice response to said follow-up audible stream,
deriving a fourth user characteristic for said user based on said second voice response, and
applying at least one of said third user characteristic and said fourth characteristic to create said user profile.

28. The method of claim 27, wherein deriving any of said third user characteristic and said fourth user characteristic comprises deriving based on an attribute of at least one of said first voice response and said second voice response, said attribute selected from the group consisting of: a message content, a word enunciation rate, a volume, a pitch, a tone, an accent, a gender characteristic, and an age characteristic.

29. The method of claim 27, wherein said dynamically modified property is of said follow-up audio stream, said property selected from the group consisting of: a message content, a volume level, a word enunciation rate, a pitch, a tone, an accent, a gender characteristic, an age characteristic, and an accent characteristic.

30. The method of claim 21, further comprising matching said user with one of multiple service providers by fitting at least one factor of said user profile to at least one factor of at least one of said multiple service provider profiles.

31. The method of claim 30, wherein said multiple service provider profiles are based on a criterion selected from the group consisting of: a service type, a service quality, a service speed, a demographic niche, a socio-economic niche, a tolerance threshold relating to a probability of said user accepting a quote, a tolerance threshold relating to binding said user to an offer, and a tolerance relating to an expected user life time value.

32. The method of claim 30, further comprising receiving a confirmation from said user with respect to said matching, establishing a communication channel between said user and said matched one of said multiple service providers, and providing, to said matched one of said multiple service providers, at least one aspect of said user profile.

33. The method of claim 30, further comprising creating said multiple service provider profiles corresponding to each of said multiple service providers.

34. A system for creating a user profile via a dynamically adaptive user interface (UI), the system comprising:
a communication network; and
a server computing device comprising at least one server-side processor, said server side computing device configured to communicate with multiple user devices and multiple service provider devices via a communication channel of said communication network,
wherein said at least one server-side processor is configured to:
provide an adaptive user interface (UI) for at least visually engaging in an interactive communication with a user of said user device, display, on said user device via said adaptive UI, an image prompting said user to provide a first display response;
receive said first display response;
derive a first user characteristic based on at least one of multiple information vectors associated with said user, said multiple information vectors comprising at least said first display response;
apply said first user characteristic to dynamically modify a display property of a follow-up image prompting said user for a second display response via said adaptive UI, wherein said modified display property is configured to facilitate said engagement with said user via said adaptive UI;
display said follow-up image on said user device via said adaptive UI;
receive said second display response;
derive a second user characteristic for said user based on said second display response; and
apply at least one of said first user characteristic and said second characteristic to create a user profile for said user.

35. The system of claim 34 wherein said user profile is based on at least one factor selected from the group consisting of: a sought service type, a sought service quality, a sought service speed, a risk niche, a demographic niche, a socio-economic niche, an age attribute, a health attribute, a quote acceptance likelihood, a binding likelihood, an expected life time value, a probability of fraud, user intent, and a probability of conversion via a fully online process.

36. The system of claim 34, wherein said multiple information vectors further comprise a vector selected from the group consisting of: a behavior of said user while engaging with said adaptive UI, a hardware configuration of said user device, a software configuration of said user device, a type of said user device, a characteristic of said communication channel, a bandwidth rate, a geographic location of said user device, a location type associated with said geographic location, an ad vector facilitating said engaging with said user, a search query facilitating said engaging with said user, a time of said visually engaging in said interactive communication, a date of said visually engaging in said interactive communication, and an anomaly associated with said user.

37. The system of claim 36, wherein said behavior is an attribute selected from the group consisting of: a data entry rate, a delay, an error rate, an error type, and use of an auto-fill tool.

38. The system of claim 34, wherein said modified display property is selected from the group consisting of: a font size, a font style, a font color, a background color, a background texture, a background context, a display orientation, a display content characteristic, an image size, an image style, an image color, an image brightness, an image saturation, an image resolution, an image opacity, and an image context.

39. The system of claim 34, wherein said adaptive UI is further equipped with an automated agent configured to audibly engage in a conversation with said user by playing an audio stream prompting said user to provide a first voice response, and receiving said first voice response via a microphone of said user device,
wherein said at least one server-side processor is further configured to derive a third user characteristic for said user based on said first voice response, and
apply said third user characteristic to dynamically modify a property of said adaptive UI relating to at least one of a follow-up audio stream and a second follow-up image, wherein said modified property is configured to facilitate said engaging with said user.

40. The system of claim 39, wherein said automated agent is further configured to play said follow-up audible stream, and receive a second voice response to said follow-up audible stream, and wherein said computing device is further configured to derive a fourth user characteristic for said user based on said second voice response, and apply at least one of said third user characteristic and said fourth characteristic to create said user profile.

41. The system of claim 40, wherein deriving any of said third user characteristic and said fourth user characteristic comprises deriving based on an attribute of at least one of said first voice response and said second voice response, said attribute selected from the group consisting of: a message content, a word enunciation rate, a volume, a pitch, a tone, an accent, a gender characteristic, and an age characteristic.

42. The system of claim 39, wherein said dynamically modified property is of said follow-up audio stream, said property selected from the group consisting of: a message content, a volume level, a word enunciation rate, a pitch, a tone, an accent, a gender characteristic, an age characteristic, and an accent characteristic.

43. The system of claim 34, wherein said at least one server-side processor is further configured to match said user with one of multiple service providers by fitting at least one factor of said user profile to at least one factor of at least one of said multiple service provider profiles.

44. The system of claim 43, wherein said service provider profiles are based on a criterion selected from the group consisting of: a service type, a service quality, a service speed, a demographic niche, a socio-economic niche, a tolerance threshold relating to a probability of said user accepting a quote, a tolerance threshold relating to binding said user to an offer, and a tolerance relating to an expected user life time value.

45. The system of claim 43, wherein said at least one server-side processor is further configured to receive a confirmation from said user with respect to said matching, establish a communication channel between said user and said matched one of said multiple service providers, and provide, to said matched one of said multiple service providers, at least one aspect of said user profile.

46. The system of claim 43, wherein said at least one server-side processor is further configured to create said multiple service provider profiles corresponding to each of said multiple service providers.
